(19) United States
(12) Patent Application Publication
(10) Pub. No.: US 2016/0040737 A1
(43) Pub. Date: Feb. 11, 2016

(54) DEVICE FOR PROTECTING MECHANICAL PARTS

(71) Applicant: 3X ENGINEERING, Monaco (FR)

(72) Inventor: Stanislas BOULET D'AURIA, Monaco (MC)

(73) Assignee: 3X ENGINEERING, Monaco (MC)

(21) Appl. No.: 14/770,116

(22) PCT Filed: Feb. 28, 2014
(86) PCT No.: PCT/FR2014/000049

§ 371 Date: Oct. 16, 2015

(30) Foreign Application Priority Data
Feb. 28, 2013 (FR) 1351807

(51) Int. Cl. F16F 3/087; F16F 15/08; F16L 57/06

(52) U.S. Cl. CPC F16F 3/0873; F16L 57/06; F16F 15/08

(57) ABSTRACT

A device (10) for protecting a mechanical part (20) against damage, in particular corrosion, said mechanical part being on a support (22), or being under pressure as a result of weight, in particular, including a flexible area (12) designed to be in direct contact with the mechanical part and at least one row of rectilinear pads (14) designed to be in direct contact with the support, said row comprising a plurality of pads (14-1, 14-2, 14-3) rigidly connected to the flexible area and more rigid than the flexible area. Preferably, the pads are rectangular in shape.

### SCOPE OF THE INVENTION

The present invention relates to a device for protecting mechanical parts likely to be exposed to a force, friction or vibrations. It applies in particular to the protection against damage, notably due to the corrosion of supported valves and piping, at the location of the contact with their support.

### PRIOR ART

It is known to place, between two mechanical parts intended to be supported and for which it is desired that corrosion be limited, a half shell made of a composite material, the surface shape of which is adapted to the shape of one of the parts. For example, in order to protect a circular-based cylindrical pipe, a half shell of cylindrical shape, having an internal diameter equal to the external diameter of the pipe, is placed between this pipe and a support.

These half-shell systems present numerous drawbacks. Firstly, they require a corresponding half shell for each diameter of pipe.

The solution is also known which consists in placing a piece of elastomer or thermoplastic between the parts on the contact area. However, this material is rapidly crushed and rendered inefficient.

### OBJECT OF THE INVENTION

The present invention seeks to overcome some or all of these disadvantages.

The present invention thus relates to a device for protecting against damage, in particular corrosion, a mechanical part bearing on a support, or being under pressure, notably as a result of weight, such a device comprising a flexible area designed to be in direct contact with the mechanical part and at least one row of rectilinear pads designed to be in direct contact with the support, the row of pads having a plurality of pads rigidly connected to the flexible area and more rigid than the flexible area.

Thanks to this device, mechanical protection is placed between these parts by rigidly connecting the flexible area to one of the parts. The device also absorbs mechanical vibrations between the protected parts. Thus, the same protective device may be used for various diameters of pipe, which thus also reduces the storage and warehousing requirements. Moreover, the flexibility of the device, at least in one direction, reduces the need to level, polish or adjust the surface of the parts. The device of the present invention thus limits corrosion between the protected parts. The device of the present invention ensures at least the same protection as a half shell, without the disadvantages of the latter and has a service life much greater than that of coatings made of elastomeric material. Moreover, devices adapted to different diameters or part sizes and different mechanical forces to be supported, by different weights for example, can be easily foreseen. Moreover, this device can be used as a spacer for the parts that are not arranged close enough together to be supported directly, for example in the case of a series of supports along a pipe, when one of the supports is at a height lower than that of the two other supports.

In some embodiments, the mechanical part (22) is a pipe.

In some embodiments, the pads are rectangular in shape.

In some embodiments, the pads have a width between 20 mm and 30 mm and a length between 10 mm and 30 mm.

In some embodiments, the interval between two pads is between one-half their length and one times their width.

In some embodiments, the flexible area comprises at least one woven layer.

Thanks to these features, the device benefits from the homogeneity and resistance specific to fabrics.

In some embodiments, at least a portion of the plurality of pads is made of plastic material.

Thanks to these features, the pads are very rigid. The plastic material from which the pads are made ensure electrical, or even thermal, insulation between the parts. Moreover, the pads thus absorb various vibrations between the parts that they separate.

In some embodiments, at least a portion of the plurality of pads comprises two combined materials, one of said materials being more flexible than the other.

This combination is, for example, a weave or an overlay. Thanks to each of these features, these pads have greater vibration and shock absorbing capacity.

In some embodiments, the more flexible material is encased by the more rigid material.

Thanks to these features, the device may be applied to non-cylindrical parts or pass over surface irregularities on cylindrical parts, such as welds forming bumps on pipes, for example. The device is thus flexible in two orthogonal directions.

In some embodiments, the most rigid material is polyphenylene sulfide (P.P.S.).

In some embodiments, the flexible area and the pads are formed of the same homogeneous material.

For example, the flexible area and the pads are made from a single and homogeneous block of material. This block, made of a single material, may be shaped to form the flexible zone and the pads by machining, moulding, injection or extrusion, for example. For example, the flexible area has a thickness less than or equal to one millimetre in order to have the necessary flexibility.

### BRIEF DESCRIPTION OF DRAWINGS

The advantages, objects and features of the present invention will become apparent from the following description, provided for explanatory purposes and in a non-exhaustive manner, when taken in conjunction with the accompanying drawings wherein:

FIG. 1 represents, schematically and in cross-section, the embodiment of the device of the present invention placed between a pipe to be protected and a support;

FIG. 2 represents, schematically and in perspective, the preferred embodiment of the device of the present invention; and

FIGS. 3, 4 and 5 represent cross sections of pads of various embodiments of the device of the present invention.

### DETAILED DESCRIPTION OF THE INVENTION

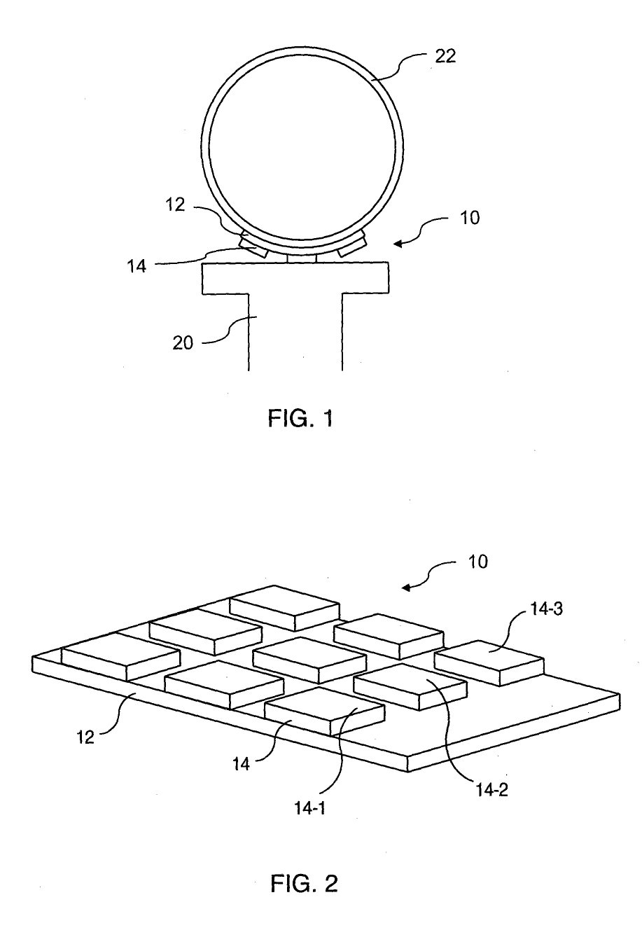

As illustrated in FIG. 1, the protection device 10 according to the invention is positioned between two parts 20 and 22 for which it is desired to limit corrosion, wear or vibration. For example, part 20 is a support placed in a platform or on the seabed and part 22 is a pipe.

The device 10 comprises a flexible zone 12 and, rigidly connected to the flexible area 12, a plurality of rows of pads 14 more rigid than the flexible area.

As seen in FIG. 1, the part 22, here shown as piping such a pipeline, is supported on a single row of pads, such that the bearing surface of the piping on the support 20 is as large as possible. However, the other rows of pads on either side are necessary to the extent that, in case of deterioration of the bearing row, these rows will be useful in always ensuring that the pipe is supported.

FIG. 2 illustrates an embodiment 10 of the device for protecting mechanical parts of the present invention having a flexible zone 12 and several rows of pads 14 more rigid than the flexible area, each row of pads being comprised of several pads, such as pads 14-1, 14-2 and 14-3, for example.

Although a one-piece pad may be used within the scope of the invention, dividing each row of pads into several pads is very useful. The surface of the piping 22 degrades over time. Consequently, recesses form on the outer surface of the piping where the metal has left and bumps form as a result of oxidation. As the piping is no longer rectilinear, having a plurality of pads allows the row to compensate for the surface irregularities of the piping over time.

According to particular embodiments of the invention, the pads, such as pads 14-1, 14-2, 14-3 illustrated in FIG. 2, are rectangular and particularly square in shape. Preferably, the pads are between 5 mm and 10 mm thick, 20 mm to 30 mm wide and 10 mm to 30 mm long. The interval between two pads may be between one-half of their length and one times their width. Thus, with pads measuring 30 mm in length, the interval between two pads will be between 15 mm and 30 mm.

It should be noted that the height of the pads and the spacing between each pad are such that the piping 22 shall in no case touch the support through the flexible area.

The flexibility of the flexible area allows relative movement between the pads and permits the entire device 10 to run along the surface of a mechanical part to be protected.

The flexible area 12 can be made of elastic material. Preferably, the flexible area 12 comprises at least one woven layer. A woven layer has the advantage of possessing a high degree of homogeneity and fabric-specific resistance.

The pads 14-1, 14-2, 14-3 are rigid without being brittle. Preferably, the pads comprise a plastic material, and/or a non-ferrous metal, such as bronze for example. Their rigidity is thus very high. The plastic material provides electrical, and even thermal insulation and absorbs various vibrations between the parts. Non-ferrous metal, such as bronze for example, is not subject to corrosion.

Advantageously, each pad comprises a plastic or resinous material loaded with material designed to limit abrasion. Thus, the friction resistance of the pad is improved by the material filler adapted to limit abrasion. The pads are progressively polished, which promotes the sliding of the pipe on the support. Advantageously, each pad is obtained through pultrusion, extrusion, multi-extrusion or injection. The pads are thus easily produced, notably with a wall cross-section of various thicknesses so as to create various cross-sections and it is possible to use, in the same cross-section, different materials that are, for example, rigid to prevent abrasion and flexible to absorb vibrations.

To manufacture the device 10, the flexible area 12 may comprise a mesh, braid or weave, which is placed into contact with each pad 14 during a moulding step of each pad 14. In other manufacturing methods, each pad 14 is secured to the flexible area while still liquid so that the flexible area 12 penetrates the material of the pad 14. The pad 14 and the flexible area 12 are thus particularly well-bonded.

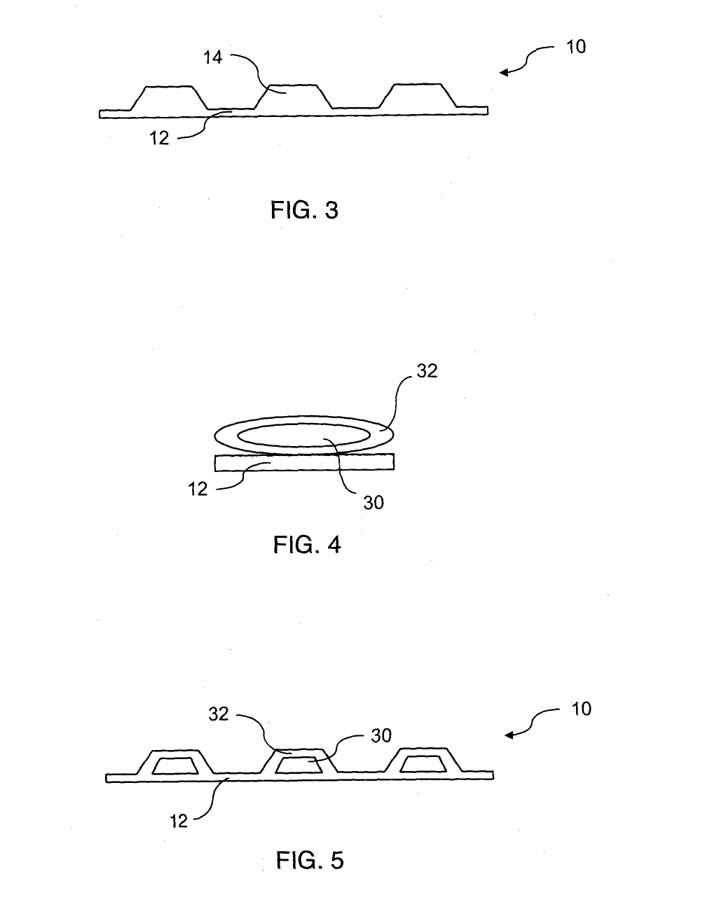

In some embodiments, the flexible area 12 and the pads 14 are made of the same material, as illustrated in FIG. 3. This block, made of a single material, may be shaped to form the flexible zone and the pads by machining, moulding, injection or extrusion, for example. These embodiments have the advantage of being very inexpensive to manufacture, owing to their manufacturing method, notably when extrusion or pultrusion methods are used.

In some embodiments, each pad 14 is bonded or welded to the flexible area 12.

In some embodiments, as illustrated in FIGS. 4 and 5, the pad is made of two materials, one of which encompasses the other to ensure better contact with the parts to be protected and to improve the vibration and shock absorbing capacity. Preferably, the more flexible material 30, such as rubber for example, is encased in the more rigid material 32, such as polyphenylene sulfide (P.P.S.), for example.

Preferably, during the manufacture of the device 10, a strip of material is produced which is wound into coil. The device 10 is then obtained by cutting off the strip thus manufactured to the dimensions corresponding to the piping and the support to be protected.

In order to implement the device of the present invention, the following process is applied in order to protect a pipe 22 resting on a support 20:
a step in which a roll of material, described above, is cut between two pads to form a protective device 10. The size of the protective device 10 depends on the parts to be protected. The thickness and the length of the pads 14 depend on the pressure exerted by the piping and expected slippages. Two or three types of pads are considered in order to meet all the requirements for piping ranging in diameter from two to fifty-six inches (approx. 5 to 140 cm).
a step of raising the pipe 22, according to known techniques,
a surface preparation step of at least one said part, of pipe 22 for example, by shotpeening and degreasing for example,
a step of impregnating the prepared surface and/or the flexible area 12 of the device 10, for example with adhesive, of polymerisable resin for example, configured to harden under the effect of radiation, heat or a chemical reaction between components,
a positioning step in a manner such that at least the entire contact surface of one of the pads is parallel to the face of the support intended to receive the pipe, and
a pressing step of the area 12 on the adhesive and on the surface of the prepared part, by banding with at least one tight strap, for example, around the device 10 and pipe 22 that it supports. The adhesive then hardens, thereby bonding the device 10 to the pipe 22.

Of course, the two surfaces in contact may be subject to separate protection.
a step for installing the pipe 22, according to known techniques

As can be understood from reading the description above, by joining the flexible area to one of the parts, mechanical protection is achieved between the parts to be protected. The device of the invention also absorbs mechanical vibrations between the protected parts. In addition, the same protective device may be used for different pipe diameters, which thus also reduces the storage and warehousing requirements.

The flexibility of the device, at least in one direction, limits the need for surface treatment of the parts. The device of the present invention thus limits corrosion between the protected parts. In addition, devices can easily be provided which are adapted to different diameters or sizes of parts to be protected.

The device of the present invention does not apply only to pipes. It applies in all cases where mechanical parts are in contact and at least one of these parts requires protection from corrosion, vibration, impact, or reaction with a material comprising the other part, for example.

1. Dispositif (10) de protection contre la dégradation, notamment la corrosion, d'une piece mecanique (20), en appui sur un support (22), ou sous pression due notamment au poids;
une zone souple (12) adaptee pour être en contact direct avec la pièce mécanique et
au moins une rangee de patins rectilgne (14) adaptee pour être en contact direct avec le support, ladite rangée comportant une pluralité de patins (14-1, 14-2, 14-3) solidarisés à ladite zone souple et plus rigides que ladite zone souple.

2-11. (canceled)
